(19) United States
(12) Patent Application Publication
(10) Pub. No.: US 2025/0079511 A1
(43) Pub. Date: Mar. 6, 2025

(54) SOLID ELECTROLYTE COMPOSITION AND METHOD FOR MANUFACTURING THE SAME

(71) Applicants: Panasonic Holdings Corporation, Osaka (JP); TOYOTA JIDOSHA KABUSHIKI KAISHA, Aichi (JP)

(72) Inventors: Yusuke NISHIO, Osaka (JP); Kouji NISHIDA, Osaka (JP); Hiroki YABE, Osaka (JP)

(21) Appl. No.: 18/951,048

(22) Filed: Nov. 18, 2024

Related U.S. Application Data
(63) Continuation of application No. PCT/JP2023/007882, filed on Mar. 2, 2023.

(30) Foreign Application Priority Data
May 19, 2022 (JP) 2022-082576

(51) Int. Cl. H01M 10/0562

(52) U.S. Cl. CPC H01M 10/0562; H01M 2300/008

(57) ABSTRACT

A solid electrolyte composition of the present disclosure including a solvent, an active material, and a solid electrolyte, is powdery or clayey, in which the active material and the solid electrolyte form a composite. A solid content ratio of the solid electrolyte composition is, for example, 72 mass % or more and 88 mass % or less. An electrode slurry is obtainable by adding a solvent to the solid electrolyte composition. An electrode and a battery can be produced using the electrode slurry.

This application is a continuation of PCT/JP2023/007882 filed on Mar. 2, 2023, which claims foreign priority of Japanese Patent Application No. 2022-082576 filed on May 19, 2022, the entire contents of which are incorporated herein by reference.

### BACKGROUND OF THE INVENTION

### 1. Field of the Invention

The present disclosure relates to a solid electrolyte composition and a method for manufacturing the same.

### 2. Description of Related Art

A dry method and a wet method are known as methods for manufacturing a battery electrode. The wet method means a method using a slurry that includes materials such as a solvent, an active material, a solid electrolyte, or the like. The dry method means a method using no solvent. WO 2020/241322 A1 and JP 2020-53307 A each discloses a method for manufacturing an electrode for an all-solid-state battery, using a slurry.

### SUMMARY OF THE INVENTION

In the conventional techniques, it is desirable to increase the discharge capacity of a battery.

The present disclosure provides a solid electrolyte composition including:
a solvent;
an active material; and
a solid electrolyte, wherein
the solid electrolyte composition is powdery or clayey, and
the active material and the solid electrolyte form a composite.

With a solid electrolyte composition of the present disclosure, it is possible to increase a discharge capacity of a battery.

### BRIEF DESCRIPTION OF THE DRAWINGS

FIG. 1 is a cross-sectional view showing a schematic configuration of a solid electrolyte composition according to Embodiment 1.

FIG. 2 is a process chart showing a method for manufacturing a solid electrolyte composition.

FIG. 3 is a process chart showing a method for manufacturing a slurry including a solid electrolyte composition.

FIG. 4 is a cross-sectional view showing a schematic configuration of a battery according to Embodiment 2.

FIG. 5A is a SEM image of NCM before high-shear kneading.

FIG. 5B is a SEM image of a composite of NCM and LYBC after high-shear kneading.

### DETAILED DESCRIPTION

(Findings on which the Present Disclosure is Based)

The wet method has an advantage from a viewpoint that it enables to decrease variation in the electrode characteristics. However, the wet method tends to increase the resistance of the battery though the reason is not always clarified. The increase in the resistance of the battery may cause a decrease in the discharge capacity.

The present inventor conducted extensive research into techniques for lowering the resistance of a battery and increasing the discharge capacity. As a result, the present inventor discovered that the discharge capacity of a battery can be increased by high-shear kneading a mixture including a solvent, an active material, and a solid electrolyte.

### (Overview of One Aspect According to the Present Disclosure)

A solid electrolyte composition according to a first aspect of the present disclosure includes:
a solvent;
an active material; and
a solid electrolyte, wherein
the solid electrolyte composition is powdery or clayey, and
the active material and the solid electrolyte form a composite.

With the solid electrolyte composition according to the present disclosure, it is possible to increase the discharge capacity of the battery. Furthermore, since the active material and the solid electrolyte form a composite, it is possible to effectively lower the resistance of the battery.

In a second aspect of the present disclosure, for example, in the solid electrolyte composition according to the first aspect, the solid electrolyte composition may be clayey. In the case where the solid electrolyte composition is clayey, the aforementioned effects can be obtained further sufficiently.

In a third aspect of the present disclosure, for example, in the solid electrolyte composition according to the first or second aspect, the solid content ratio may be 72 mass % or more and 88 mass % or less. In the case where the solid content ratio is within the range, the aforementioned effects can be obtained further sufficiently.

In a fourth aspect of the present disclosure, for example, the solid electrolyte composition according to any one of the first to third aspects may be free of a binder. In the case where the solid electrolyte composition is free of a binder, enhancement in the ionic conductivity of the electrode and enhancement in the electronic conductivity of the electrode can be expected.

A method for manufacturing a solid electrolyte composition according to a fifth aspect of the present disclosure includes high-shear kneading a mixture including a solvent, an active material, and a solid electrolyte.

In the manufacturing method of the present disclosure, the active material and the solid electrolyte efficiently form a composite.

In a sixth aspect of the present disclosure, for example, in the manufacturing method according to the fifth aspect, the mixture may be clayey. In the case where the mixture is clayey, it is possible to perform high-shear kneading using a device such as a kneader or a planetary mixer, thereby efficiently advancing formation of a composite of the active material and the solid electrolyte.

In a seventh aspect of the present disclosure, for example, in the manufacturing method according to the fifth or sixth aspect, a solid content ratio of the mixture may be 72 mass % or more and 88 mass % or less.

In an eighth aspect of the present disclosure, for example, in the manufacturing method according to the fifth or sixth aspect, the solid content ratio of the mixture may be 77 mass % or more and 84 mass % or less. If the solid content ratio is properly adjusted, the mixture can be kneaded easily and sufficiently.

In a ninth aspect of the present disclosure, for example, in the manufacturing method according to any one of the fifth to the eighth aspects, the mixture may be free of a binder. If the solid content ratio is properly adjusted, the mixture can be easily and sufficiently kneaded.

In a tenth aspect of the present disclosure, for example, in the manufacturing method according to any one of the fifth to ninth aspects, the solid electrolyte may include at least one selected from the group consisting of a sulfide solid electrolyte and a halide solid electrolyte.

A method for manufacturing an electrode slurry according to an eleventh aspect includes adding a solvent to the solid electrolyte composition according to any one of the first to fourth aspects.

A method for manufacturing an electrode according to a twelfth aspect of the present disclosure includes molding a solid electrolyte composition according to any one of the first to fourth aspects.

A method for manufacturing a battery according to a thirteenth aspect of the present disclosure includes molding the solid electrolyte composition according to any one of the first to fourth aspects.

In the eleventh to thirteenth aspects, the resistance of the battery can be further lowered and the charge and discharge characteristics can be enhanced.

Embodiments of the present disclosure will be described below with reference to the drawings.

### Embodiment 1

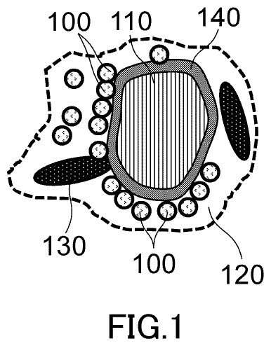

FIG. 1 is a cross-sectional view showing a schematic configuration of a solid electrolyte composition 1000 in Embodiment 1. The solid electrolyte composition 1000 includes a solid electrolyte 100, an active material 110, and a solvent 120. The solid electrolyte composition 1000 is a powdery or clayey solidified product.

The solid electrolyte composition 1000 is obtained by high-shear kneading a mixture including the solvent 120, the active material 110, and the solid electrolyte 100. High-shear kneading serves to form a favorable interface between the active material 110 and the solid electrolyte 100. Thereby, a substantial reaction area is increased and the resistance of the battery is lowered. As a result, the discharge capacity of the battery can be increased.

The solid electrolyte composition 1000 is preferably clayey. In the case where the solid electrolyte composition 1000 is clayey, the aforementioned effects can be obtained further sufficiently. The solid electrolyte composition 1000 has no flowability of slurry while it retains a definite shape.

In the solid electrolyte composition 1000, the active material 110 and the solid electrolyte 100 form a composite. This configuration can effectively lower the resistance of the battery. As a result, the discharge capacity of the battery can be increased.

The expression “an active material 110 and a solid electrolyte 100 form a composite” means that the solid electrolyte 100 adheres to the particulate active material 110 so as to cover at least a part of the surface of the active material 110.

The solvent 120 adheres to the surface of the composite of the active material 110 and the solid electrolyte 100.

The solid content ratio of the solid electrolyte composition 1000 may be 72 mass % or more and 88 mass % or less. In the case where the solid content ratio is within this range, the aforementioned effects can be obtained further sufficiently. The solid content ratio of the solid electrolyte composition 1000 may be 77 mass % or more and 84 mass % or less.

The solid electrolyte composition 1000 may be free of a binder. In the case where the solid electrolyte composition 1000 is free of a binder, enhancement in the ionic conductivity of the electrode and enhancement in the electronic conductivity of the electrode can be expected.

The solid electrolyte composition 1000 may include a conductive additive 130. The conductive additive 130 contributes to formation of an electron conduction pathway inside the battery.

For the active material 110, a material applicable as an active material in a lithium-ion secondary battery is used. The active material 110 is, for example, a positive active material.

Examples of the positive electrode active material include LiCoO₂, LiNiₓMe₁₋ₓO₂ (0.5≤x<1, where the Me is at least one selected from the group consisting of Co, Mn and Al), LiNiₓCo₁₋ₓO₂ (0<x<0.5), LiNi_{1/3}Co_{1/3}Mn_{1/3}O₂, LiMnO₂, a heteroelement-substituted Li—Mn spinel, lithium titanate, lithium metal phosphate, and a transition metal oxide. Examples of the heteroelement-substituted Li—Mn spinel include LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄, and LiMn_{1.5}Zn_{0.5}O₄. Examples of the lithium titanate include Li₄Ti₅O₁₂. Examples of the lithium metal phosphate include LiFePO₄, LiMnPO₄, LiCoPO₄, and LiNiPO₄. Examples of the transition metal oxide include V₂O₅ and MoO₃.

Among these materials, a lithium-containing composite oxide is preferred, where the lithium-containing composite oxide is included in LiCoO₂, LiNiₓMe₁₋ₓO₂ (0.5≤x<1, the Me includes at least one selected from the group consisting of Co, Mn, and Al), LiNiₓCo₁₋ₓO₂ (0<x<0.5), LiNi_{1/3}Co_{1/3}Mn_{1/3}O₂, LiMnO₂, a heteroelement-substituted Li—Mn spinel, or lithium metal phosphate. A lithium-containing composite oxide having a stratified rock salt structure is further preferred.

The active material 110 may be a negative electrode active material. Examples of the negative electrode active material include a metal material, a carbon material, an oxide, a nitride, a tin compound, and a silicon compound. The metal material may be a single metal or an alloy. Examples of the metal material include a lithium metal and a lithium alloy. Examples of the carbon material include natural graphite, coke, partially-graphitized carbon, a carbon fiber, spherical carbon, artificial graphite, and amorphous carbon. From the viewpoint of capacity density, silicon (Si), tin (Sn), a silicon compound, or a tin compound can be preferably used.

The active material 110 is, for example, particulate. The shape of particles of the active material 110 is not particularly limited. The particles of the active material 110 can be spherical, ellipsoidal, scaly, or fibrous.

The active material 110 may be coated with a coating material 140. The coating material 140 may coat the entire surface of the active material 110, or may coat a part of the surface of the active material 110.

The coating material 140 may include Li and at least one element selected from the group consisting of O, F, and Cl.

The coating material 140 may include at least one selected from the group consisting of lithium niobate, lithium phosphate, lithium titanate, lithium tungstate, lithium fluorozirconate, lithium fluoroaluminate, lithium fluorotitanate, and lithium fluoromagnesium oxide.

The solid electrolyte 100 may include at least one selected from the group consisting of a sulfide solid electrolyte and a halide solid electrolyte. With the above configuration, the output characteristics of the battery can be enhanced. The sulfide solid electrolyte is a solid electrolyte including sulfur. The halide solid electrolyte is a solid electrolyte including halogen.

The solid electrolyte 100 may be a mixture of a sulfide solid electrolyte and a halide solid electrolyte.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂. In addition to that, a sulfide solid electrolyte having an Argyrodite structure, such as Li₆PS₅Cl, Li₆PS₅Br, Li₆PS₅I or the like may be used. To any of these sulfide solid electrolytes, LiX, Li₂O, MO_{q}, LiₚMO_{q} or the like may be added. Here, the X is at least one selected from the group consisting of F, Cl, Br and I. And M is at least one selected from the group consisting of P, Si, Ge, B, Al, Ga, In, Fe and Zn. The signs p and q are each a natural number. One or at least two sulfide solid electrolytes selected from the above materials can be used.

With the above configuration, the ionic conductivity of the sulfide solid electrolyte can be further enhanced. As a result, the charge and discharge efficiency of the battery can be further enhanced.

A halide solid electrolyte, for example, can be represented by the following composition formula (1).

Li_{α}M_{β}X_{γ} Formula (1)

Here, α, β, and γ are each independently a value larger than 0. M includes at least one element selected from the group consisting of metalloid elements and metal elements other than Li. The X includes at least one selected from the group consisting of F, Cl, Br, and I.

In the present disclosure, the “metalloid elements” refer to B, Si, Ge, As, Sb, and Te. The “metal elements” refer to all the elements included in Groups 1 to 12 of the periodic table except hydrogen and all the elements included in Groups 13 to 16 of the periodic table except B, Si, Ge, As, Sb, Te, C, N, P, O, S, and Se. In other words, the “metalloid elements” or “metal elements” are a group of elements that can be cations when forming inorganic compounds with a halogen element.

The halide solid electrolyte represented by a composition formula (1) has higher ionic conductivity when compared with the halide solid electrolyte composed of Li and a halogen element, such as LiI. Therefore, with the halide solid electrolyte represented by the composition formula (1), the ionic conductivity of the halide solid electrolyte can be further enhanced.

In the composition formula (1), M may be at least one element selected from the group consisting of a metalloid element and a metal element other than Li.

In the composition formula (1), the X may be at least one selected from the group consisting of F, Cl, Br, and I.

The composition formula (1) may satisfy 2.5≤α≤3, 1≤β≤1.1, and γ=6. With the above configuration, the ionic conductivity of the halide solid electrolyte can be further enhanced.

In the composition formula (1), M may include Y (=yttrium). That is, a halide solid electrolyte may include Y as a metal element. With the above configuration, the ionic conductivity of the halide solid electrolyte can be further enhanced.

A halide solid electrolyte including Y is, for example, a compound represented by a composition formula LiₐMe_{b}Y_{c}X₆. Here, a+mb+3c=6 and c>0 are satisfied. The Me is at least one element selected from the group consisting of metalloid elements and metal elements other than Li and Y. The sign m represents a valence of the element Me. The X is at least one selected from the group consisting of F, CI, Br, and I.

The Me may be, for example, at least one selected from the group consisting of Mg, Ca, Sr, Ba, Zn, Sc, Al, Ga, Bi, Zr, Hf, Ti, Sn, Ta, and Nb.

With the above configuration, the ionic conductivity of the halide solid electrolyte can be further enhanced.

For example, the following materials may be used as the halide solid electrolyte. With the following configuration, the ionic conductivity of the halide solid electrolyte can be further enhanced.

The halide solid electrolyte may be a material represented by the following composition formula (A1).

Li_{6-3d}Y_{d}X₆ Formula (A1)

In the composition formula (A1), the X is at least one selected from the group consisting of F, Cl, Br, and I. Also, 0<d<2 is satisfied.

The halide solid electrolyte may be a material represented by the following composition formula (A2).

Li₃YX₆ Formula (A2)

In the composition formula (A2), the X is at least one selected from the group consisting of F, Cl, Br, and I.

The halide solid electrolyte may be a material represented by the following composition formula (A3).

Li_{3-3δ}Y_{1+δ}Cl₆ Formula(A3)

In the composition formula (A3), 0<δ≤0.15 is satisfied.

The halide solid electrolyte may be a material represented by the following composition formula (A4).

Li_{3-3δ}Y_{1+δ}Br₆ Formula (A4)

In the composition formula (A4), 0<δ≤0.25 is satisfied.

The halide solid electrolyte may be a material represented by the following composition formula (A5).

Li_{3-3δ+a}Y_{1+δ-a}MeₐCl_{6-x-y}BrₓI_{y} Formula (A5)

In the composition formula (A5), the Me includes at least one selected from the group consisting of Mg, Ca, Sr, Ba, and Zn. The Me may be at least one selected from the group consisting of Mg, Ca, Sr, Ba, and Zn.

In the composition formula (A5), −1<δ<2, 0<a<3, 0<(3−3δ+a), 0<(1+δ−a), 0≤x≤6, 0≤y≤6, and (x+y)≤6, are satisfied.

The halide solid electrolyte may be a material represented by the following composition formula (A6).

Li_{3-3δ}Y_{1+δ-a}MeₐCl_{6-x-y}BrₓI_{y} Formula(A6)

In the composition formula (A6), the Me includes at least one selected from the group consisting of Al, Sc, Ga, and Bi. The Me may be at least one selected from the group consisting of Al, Sc, Ga, and Bi.

In the composition formula (A6), −1<δ<1, 0<a<2, 0<(1+δ−a), 0≤x≤6, 0≤y≤6, and (x+y)≤6, are satisfied.

The halide solid electrolyte may be a material represented by the following composition formula (A7).

Li_{3-3δ-a}Y_{1+δ-a}MeₐCl_{6-x-y}BrₓI_{y} Formula(A7)

In the composition formula (A7), the Me includes at least one selected from the group consisting of Zr, Hf, and Ti. The Me may be at least one selected from the group consisting of Zr, Hf, and Ti.

In the composition formula (A7), −1<δ<1, 0<a<1.5, 0<(3−3δ−a), 0<(1+6−a), 0≤x≤6, 0≤y≤6, and (x+y)≤6, are satisfied.

The halide solid electrolyte may be a material represented by the following composition formula (A8).

Li_{3-3δ-a}Y_{1+δ-a}MeₐCl_{6-x-y}BrₓI_{y} Formula (A8)

In the composition formula (A8), the Me includes at least one selected from the group consisting of Ta and Nb. The Me may be at least one selected from the group consisting of Ta and Nb.

In the composition formula (A8), −1<δ<1, 0<a<1.2, 0<(3−3δ−2a), 0<(1+δ−a), 0≤x≤6, 0≤y≤6, and (x+y)≤6, are satisfied.

More specifically, for example, Li₃YX₆, Li₂MgX₄, Li₂FeX₄, Li(Al, Ga, In)X₄, Li₃(Al, Ga, In)X₆ or the like can be used as the halide solid electrolyte. Here, the X is at least one selected from the group consisting of F, Cl, Br, and I.

In the present disclosure, the expression “(A,B,C)” in a chemical formula means “at least one selected from the group consisting of A, B, and C”. For example, “(Al, Ga, In)” is synonymous with “at least one selected from the group consisting of A1, Ga, and In”. The same applies to other elements.

The halide solid electrolyte may be free of sulfur. With the above configuration, generation of a hydrogen sulfide gas can be suppressed. Therefore, it is possible to provide a battery with enhanced safety.

The halide solid electrolyte may be an oxyhalide solid electrolyte including oxygen.

The shape of the solid electrolyte 100 is not particularly limited. The shape of the solid electrolyte 100 may be, for example, acicular, spherical, ellipsoidal or the like. For example, the solid electrolyte 100 may be particulate.

For example, in the case where the solid electrolyte 100 is particulate (e.g., spherical), the median diameter of the solid electrolyte 100 may be 100 μm or less. In the case where the median diameter of the solid electrolyte 100 is 100 μm or less, the active material 110 and the solid electrolyte 100 may form a favorable composite state in the solid electrolyte composition 1000. This enhances the charge and discharge characteristics of the battery.

The median diameter of the solid electrolyte 100 may be 10 μm or less. With the above configuration, the active material 110 and the solid electrolyte 100 can form a favorable composite state in the solid electrolyte composition 1000.

The median diameter of the solid electrolyte 100 may be smaller than the median diameter of the active material 110. With the above configuration, the active material 110 and the solid electrolyte 100 can form a further favorable composite in the solid electrolyte composition 1000.

The solvent 120 is selected according to reactivity with respect to the active material 110, reactivity with respect to the solid electrolyte 100, adsorption with respect to these materials, or the like. The solvent 120 is not particularly limited unless it reacts with the solid electrolyte to cause a significant decrease in the ionic conductivity. Examples of the solvent 120 suitable for halide solid electrolyte include tetralin, ethylbenzene, mesitylene, pseudocumene, xylene, cumene, 1,2,4-trichlorobenzene, chlorobenzene, 2,4-dichlorobenzene, o-chlorotoluene, 1,3-dichlorobenzene, p-chlorotoluene, 1,2-dichlorobenzene, 1,4-dichlorobutane, 3,4-dichlorotoluene, and pentane. Any one thereof or a mixture of two or more thereof can be used as the solvent 120. Examples of the solvent 120 suitable for sulfide solid electrolyte include tetralin, anisole, xylene, octane, hexane, decalin, butyl acetate, ethyl propionate, and tripropylamine. Any one thereof or a mixture of two or more thereof can be used as the solvent 120. The solvent 120 may be selected according to the type of conductive additive and binder.

Examples of the conductive additive 130 include: graphite, such as natural graphite or artificial graphite; carbon black, such as acetylene black, furnace black, or Ketjenblack; a conductive fiber, such as a carbon fiber or a metal fiber; carbon fluoride; a metal powder, such as an aluminum powder; a conductive whisker, such as a zinc oxide whisker or a potassium titanate whisker; a conductive metal oxide, such as titanium oxide; or a conductive polymer compound, such as polyaniline, polypyrrole, or polythiophene. Using a conductive carbon additive can seek cost reduction.

With the above configuration, the resistance of the battery can be further reduced and the charge and discharge characteristics can be enhanced.

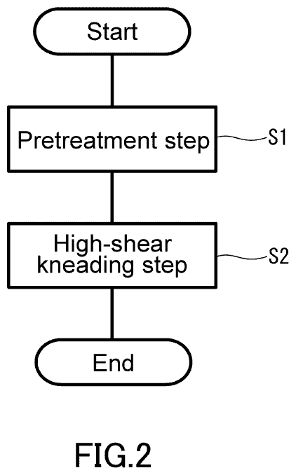

Next, the method for manufacturing the solid electrolyte composition 1000 will be described. FIG. 2 is a process chart showing a method for manufacturing the solid electrolyte composition 1000.

A pretreatment step of Step S₁ is a step to pulverize and crush the solid electrolyte 100 for controlling the particle diameter and to disperse the solid electrolyte 100 in a solvent for suppressing agglomeration. In the pretreatment step, a dispersant and/or a binder may be used to enhance the efficiency of pulverizing and crushing. The pretreatment step may enhance the efficiency of a high-shear kneading step and the efficiency in manufacturing a battery. The pretreatment step may be omitted.

The pretreatment step may be performed with respect to the active material 110.

In Step S₂, a high-shear kneading step is performed. The high-shear kneading step refers to a step of kneading a powdery or clayey solidified product that is a mixture of a solid and a liquid.

In the high-shear kneading step, first, the active material 110, the solid electrolyte 100, and the solvent 120 are mixed to prepare a mixture. Then, the mixture is high-shear kneaded. Thereby, formation of a composite of the active material 110 and the solid electrolyte 100 is advanced efficiently. As the active material 110, a single material may be used, or a plurality of materials may be used in combination. As the solid electrolyte 100, a single material may be used, or a plurality of materials may be used in combination. As the solvent 120, a single material may be used, or a plurality of materials may be used in combination.

In the above mixture, the mass ratio of the active material 110 to the solid electrolyte 100 is not particularly limited. For example, the mass ratio of the active material 110 to the solid electrolyte 100 can be adjusted in the range of (active material):(solid electrolyte)=99.5:0.5 to 60:40.

The solid content ratio of the mixture may be, for example, 72 mass % or more and 88 mass % or less, or 77 mass % or more and 84 mass % or less in order to efficiently advance formation of the composite of the active material 110 and the solid electrolyte 100. When the solid content ratio is properly adjusted, the mixture can be easily and sufficiently kneaded. In other words, since the mixture has no flowability of a slurry while it has an appropriate viscosity, shear force is easily applied to the mixture during the high-shear kneading. As a result, high-shear kneading can be performed efficiently. Formation of the composite of the active material 110 and the solid electrolyte 100 can also easily be advanced constantly.

In one example, the mixture used for the high-shear kneading is clayey. If the mixture is clayey, high-share kneading is performed using a device such as a kneader or a planetary mixer, so that formation of a composite of the active material 110 and the solid electrolyte 100 can be efficiently advanced.

The treatment time for the high-shear kneading step is not particularly limited. For example, the treatment time is properly adjusted in the range from 30 minutes to several hours. In order to avoid reaction between the solid electrolyte 100 and moisture in the air, it is desirable to perform the high-shear kneading step in an inert atmosphere with a low dew point. For example, the high-shear kneading step may be performed in an argon atmosphere or a dry air atmosphere with a dew point of −60° C. or lower. In the case where the temperature of the mixture rises due to friction, the high-shear kneading step may be performed while cooling the mixture.

The mixture to be high-shear kneaded may be free of a binder. If a binder is included, the liquid retention of the mixture and the viscosity of the solid electrolyte composition will increase, so that the high-shear kneading step can be efficiently performed. However, if the binder covers the surfaces of the active material 110 and the solid electrolyte 100, the binder becomes a factor to inhibit electronic conductivity and lithium ionic conductivity. In the case where no binder is included, enhancement in the electronic conductivity and lithium ionic conductivity can be expected.

In the mixture to be high-shear kneaded, the content of the polymeric material functioning as a binder may be 0.1 mass % or less. Similarly, in the solid electrolyte composition 1000 obtainable by the high-shear kneading, the content of the polymeric material functioning as a binder may be 0.1 mass % or less.

As the solid electrolyte 100, at least one selected from the group consisting of the sulfide solid electrolyte and halide solid electrolyte described above can be used. These solid electrolytes are solid electrolytes that are relatively deformable, and are therefore suitable for manufacturing the solid electrolyte composition 1000 by high-shear kneading. In the case where a solid material such as the active material 110 or the solid electrolyte 100 is deformable, formation of a composite of the active material 110 and the solid electrolyte 100 by high-shear kneading can be advanced efficiently. For the high-shear kneading step, a high-torque device capable of mixing and kneading materials with a strong shear force, such as a kneader or a planetary mixer, is suitable. These devices may be operated at a low-speed rotation of 1000 rpm or less.

The mixture to be high-shear kneaded may include a conductive additive. Further, similarly to the solid electrolyte 100, the conductive additive may be subjected to a pretreatment step. In the pretreatment step, a dispersant and/or a binder may be used.

### Embodiment 2

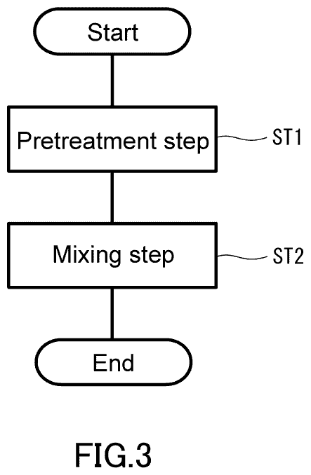

FIG. 3 is a process chart showing a step of manufacturing a slurry including the solid electrolyte composition 1000.

The solid electrolyte composition 1000 has poor flowability. It is difficult to form a coating film by directly applying the solid electrolyte composition 1000. For this reason, an electrode slurry is prepared by adding a solvent to the solid electrolyte composition 1000. If necessary, a binder, a dispersant, an additional solid electrolyte, an additional conductive additive or the like may be mixed in the solid electrolyte composition 1000.

The pretreatment step shown in Step ST1 is a step of pulverizing and crushing various materials to control particle diameters and dispersing various materials in a solvent to suppress agglomeration. The pretreatment step may be omitted.

The mixing step shown in Step ST2 is a step for mixing the solid electrolyte composition 1000 with an additional solvent. The mixing step may be a step of dispersing the solid electrolyte composition 1000 in the additional solvent. The additional solvent can be the same solvent as the solvent included in the solid electrolyte composition 1000 or a solvent different from the solvent included in the solid electrolyte composition 1000. For the mixing step, a device that can easily exhibit a dispersing action on materials of low viscosity, such as a device using high-speed rotation of 1000 rpm or more or a device using ultrasonic waves, is suitable. In this regard, the high-shear kneading step to obtain the solid electrolyte composition 1000 and the mixing step to prepare the slurry may be performed successively using a device capable of performing both the high-shear kneading step and the mixing step.

An electrode slurry is obtained through these steps. In the case where an electrode is produced using this electrode slurry thereby manufacturing a battery, the resistance of the battery can be lowered and the charge and discharge characteristics of the battery can be enhanced.

### Embodiment 3

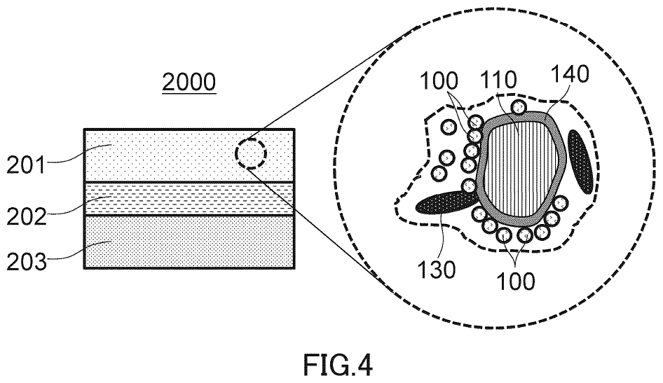

FIG. 4 is a cross-sectional view showing a schematic structure of a battery 2000 in Embodiment 3. The battery 2000 includes a positive electrode 201, an electrolyte layer 202, and a negative electrode 203. The electrolyte layer 202 is disposed between the positive electrode 201 and the negative electrode 203.

At least one of the positive electrode 201 and the negative electrode 203 can be produced by molding the solid electrolyte composition 1000. More specifically, at least one of the positive electrode 201 and the negative electrode 203 can be produced by applying an electrode slurry, which is prepared using the solid electrolyte composition 1000, to a current collector so as to form a coating film, and removing the solvent from the coating film. In an alternative method, the solid electrolyte composition 1000 is directly molded without preparing the electrode slurry.

At least one of the positive electrode 201 and the negative electrode 203 includes the active material 110 and the solid electrolyte 100. Optionally, at least one of the positive electrode 201 and the negative electrode 203 may include a binder, a dispersant, a conductive additive, or the like.

The battery 2000 is manufactured using the solid electrolyte composition 1000. Therefore, the battery 2000 can have a higher discharge voltage and a higher discharge capacity compared to a battery manufactured using a slurry prepared by mixing an active material, a solid electrolyte and a solvent.

With respect to the volume ratio of the positive active material to the solid electrolyte: “v1:100-v1”, 30≤v1≤95 may be satisfied. In the case where 30≤v1 is satisfied, the energy density of the battery 2000 is sufficiently achieved. In the case where v1≤95 is satisfied, an operation at a high power is possible. At this time, the positive electrode active material may include the active material 110. The solid electrolyte may include the solid electrolyte 100.

The positive electrode 201 may have a thickness of 10 μm or more and 500 μm or less. In the case where the thickness of the positive electrode 201 is 10 μm or more, the energy density of the battery 2000 is sufficiently achieved. In the case where the thickness of the positive electrode 201 is 500 μm or less, an operation at a high power is possible.

The electrolyte layer 202 is a layer including an electrolyte material. The electrolyte material is, for example, a solid electrolyte material. That is, the electrolyte layer 202 may be a solid electrolyte layer. As the solid electrolyte, the material exemplified as the material of the solid electrolyte 100 in Embodiment 1 may be used. In other words, the electrolyte layer 202 may include a solid electrolyte of the same constituent as the constituent of the solid electrolyte 100 included in the solid electrolyte composition 1000.

With the above configuration, the charge and discharge efficiency of the battery 2000 can be further enhanced.

The electrolyte layer 202 may include a halide solid electrolyte having a constituent different from the constituent of the solid electrolyte included in the solid electrolyte composition 1000.

The electrolyte layer 202 may include a sulfide solid electrolyte.

The electrolyte layer 202 may include only one solid electrolyte selected from the group consisting of the solid electrolytes described above, or may include two or more solid electrolytes selected from the group of the solid electrolytes described above. The solid electrolytes have constituents different from each other. For example, the electrolyte layer 202 may include a halide solid electrolyte and a sulfide solid electrolyte.

The electrolyte layer 202 may have a thickness of 1 μm or more and 300 μm or less. In the case where the thickness of the electrolyte layer 202 is 1 μm or more, the positive electrode 201 and the negative electrode 203 are unlikely to short-circuit. In the case where the thickness of the electrolyte layer 202 is 300 μm or less, an operation at a high power is possible.

The negative electrode 203 includes a material having properties of occluding and releasing metal ions (e.g., lithium ions). The negative electrode 203 includes, for example, a negative electrode active material. The negative electrode active material may include an active material 110.

The negative electrode 203 may include a solid electrolyte material. In this case, the negative electrode 203 may include the solid electrolyte 100. With the above configuration, the lithium ionic conductivity inside the negative electrode 203 is enhanced, enabling an operation at a high power. The material exemplified in Embodiment 1 may be used as the solid electrolyte. That is, the negative electrode 203 may include a solid electrolyte of the same constituent as the constituent of the solid electrolyte included in the solid electrolyte composition 1000.

The median diameter of the negative electrode active material may be 0.1 μm or more and 100 μm or less.

In the case where the median diameter of the negative electrode active material is 0.1 μm or more, the negative electrode active material and the solid electrolyte material can form a favorable dispersion state. As a result, the charge and discharge characteristics of the battery are enhanced.

In the case where the median diameter of the negative electrode active material is 100 μm or less, the diffusion rate of lithium in the negative electrode active material is sufficiently achieved. This enables the battery to operate at a high power.

The median diameter of the negative electrode active material may be larger than the median diameter of the solid electrolyte material. This allows a favorable dispersion state to be formed between the negative electrode active material and the solid electrolyte material.

With respect to the volume ratio “v2:100-v2” of the negative electrode active material to the solid electrolyte material, both being included in the negative electrode 203, 30≤v2≤95 may be satisfied. In the case where 30≤v2 is satisfied, the energy density of the battery 2000 is sufficiently achieved. In the case where v2≤95 is satisfied, an operation at a high power is possible.

The negative electrode 203 may have a thickness of 10 μm or more and 500 μm or less. In the case where the thickness of the negative electrode 203 is 10 μm or more, a sufficient energy density of the battery 2000 can be achieved. In the case where the thickness of the negative electrode 203 is 500 μm or less, an operation at a high power is possible.

At least one selected from the group consisting of the positive electrode 201, the electrolyte layer 202, and the negative electrode 203 may include a binder for the purpose of enhancing the adhesion between the particles. The binder is used to enhance the binding properties of the materials of the electrodes. Examples of the binder include polyvinylidene fluoride, polytetrafluoroethylene, polyethylene, polypropylene, aramid resin, polyamide, polyimide, polyamide imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. Furthermore, a copolymer can be used as the binder, and the copolymer is composed of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. Two or more selected from these may be mixed to be used as a binder.

At least one selected from the group consisting of the positive electrode 201 and the negative electrode 203 may include a conductive additive for the purpose of enhancing the electronic conductivity. At this time, the conductive additive may include the conductive additive 130. The conductive additive can be, for example: graphite, such as natural graphite or artificial graphite; carbon black, such as acetylene black or Ketjenblack; a conductive fiber, such as a carbon fiber or a metal fiber; carbon fluoride; a metal powder, such as an aluminum powder; a conductive whisker, such as a zinc oxide whisker or a potassium titanate whisker; a conductive metal oxide, such as titanium oxide; or a conductive polymer compound, such as polyaniline, polypyrrole, or polythiophene. Using a conductive carbon additive can seek cost reduction.

The shape of the battery 2000 is, for example, a coin type, a cylindrical type, a prismatic type, a sheet type, a button type, a flat type, or a stack type.

### EXAMPLES

The present disclosure will be described below in more detail with reference to Examples.

### Example 1

### [Production of Halide Solid Electrolyte]

In an argon glove box with a dew point of −60° C. or lower, LiBr, LiCl, and YCl₃ were weighed in a molar ratio of LiBr:LiCl:YCl₃=2:1:1. These were pulverized and mixed in a mortar to obtain a mixture. The mixture was milled with a planetary ball mill at 600 rpm for 12 hours. As a result, a halide solid electrolyte powder represented by a composition formula Li₃YBr₂Cl₄ was obtained. Hereinafter, Li₃YBr₂Cl₄ is referred to as “LYBC”.

### [Production of Solid Electrolyte Composition]

A LYBC powder and parachlorotoluene (pCT) were mixed in an environment with a dew point of −60° C. or lower, and a pretreatment of finely pulverizing the LYBC was performed using the planetary ball mill so as to obtain a suspension including the LYBC.

Li(NiCoMn)O₂ (hereinafter referred to as “NCM”) as the positive active material and the suspension were fed into a kneader (PBV-0.1 manufactured by IRIE SHOKAI Co., Ltd.) so that a mass ratio of the NCM to the LYBC would be NCM:LYBC=93.0:7.0, to which parachlorotoluene was added to adjust the solid content ratio to 80.9 mass %. High-shear kneading was then performed under the conditions of an argon atmosphere with a dew point of −60° C. at a rotation speed of 60 rpm for one hour. As a result, a solid electrolyte composition of Example 1 was obtained.

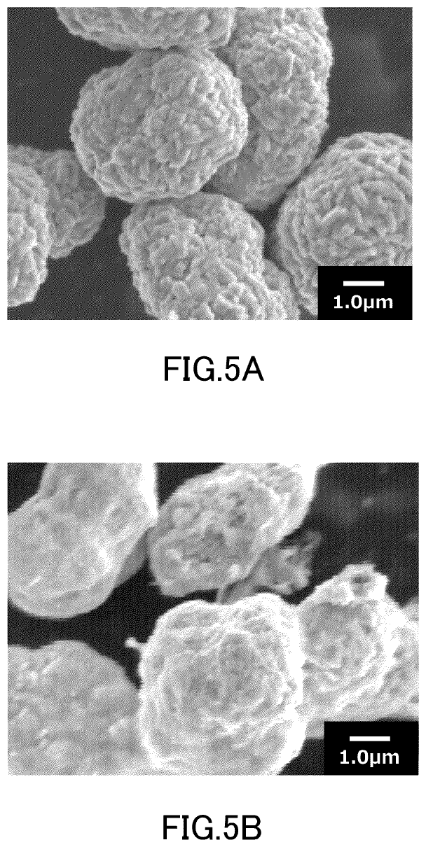

FIG. 5A is an SEM image of NCM before high-shear kneading. FIG. 5B is an SEM image of a composite of NCM and LYBC after high-shear kneading. The composite is dried for SEM observation. As shown in FIG. 5A, the NCM before the high-shear kneading was secondary particles with relatively large irregularities on the surfaces. As shown in FIG. 5B, in the composite after the high-shear kneading, the LYBC adhered to the surface of the NCM particles, whereby the irregularities were reduced and the NCM and the LYBC formed a composite.

### [Production of Positive Electrode]

The solid electrolyte composition and the suspension including the LYBC were mixed in an argon glove box with a dew point of −60° C. or lower to obtain a mixture. The ratio of the NCM to the LYBC in the mixture was NCM:LYBC=70:30 in a volume ratio. The mixture was treated in a homogenizer to disperse the NCM and the LYBC. A binder (SEBS: N504 manufactured by Asahi Kasei Corp.), a solvent, and a conductive additive (fibrous carbon: VGCF-H manufactured by Showa Denko K.K.) were added to the mixture, and these were dispersed in a homogenizer to obtain a slurry. The solvent used to make the slurry was the same as the solvent in the solid electrolyte composition (parachlorotoluene). “VGCF” is a registered trademark of Showa Denko K.K.

The slurry was applied onto the current collector to form a coating film. The coating film was dried on a hot plate to form a positive electrode.

In Examples 1 to 11 and Comparative Example 21, the thickness of the coating film was adjusted in each of the Examples and Comparative Example so that the mass of the positive active material layer after drying would be the same.

### [Production of Sulfide Solid Electrolyte]

In an argon glove box with a dew point of −60° C. or lower, Li₂S and P₂S₅ were weighed in a molar ratio of Li₂S:P₂S₅=75:25. These were crushed and mixed in a mortar to obtain a mixture. The mixture was then milled using a planetary ball mill (P-7 Model manufactured by Fritsch GmbH) at 510 rpm for 10 hours. Thereby, a glassy solid electrolyte was obtained. The glassy solid electrolyte was heat treated in an inert atmosphere at 270° C. for 2 hours. Thereby, Li₂S—P₂S₅ as a glass-ceramic solid sulfide electrolyte was obtained. Hereinafter, Li₂S—P₂S₅ is referred to as “LPS”.

### [Production of Battery]

The positive electrode was cut into a disk shape. Into an insulating outer cylinder, 80 mg of the LPS and the disk-shape positive electrode were stacked in this order. The LPS and the positive electrode were pressure-molded at a pressure of 700 MPa. Metal Li(thickness: 200 μm) was stacked on the side opposite to the positive electrode. The positive electrode, the LPS and the metal Li were pressure-molded at a pressure of 80 MPa to produce a stack composed of the positive electrode, a solid electrolyte layer, and a negative electrode. Stainless steel current collectors were disposed on the top and the bottom of the stack. Current collector leads were attached to the respective current collectors. The insulating outer cylinder was hermetically sealed using an insulating ferrule, so that the interior of the insulating outer cylinder was isolated from the outside atmosphere. Through these steps, a battery of Example 1 was produced.

### [Electrochemical Test]

The battery was placed in a thermostatic chamber at 25° C. and connected to a charge and discharge device. Constant-current charge was performed to a voltage of 4.3 V at a current value equivalent to 0.05 C rate (10-hour rate) relative to the theoretical capacity of the battery. Constant-current discharge was then performed to a voltage of 2.5 V at a 0.3 C rate, whereby the average discharge voltage and discharge capacity per unit mass were measured. The discharge capacity per unit area (mWh/cm²) at 0.3 C was obtained from the mass of the active material per unit area, the average discharge voltage and the discharge capacity per unit mass. The results are shown in Table 1. In Table 1, the item “discharge capacity” is expressed as a relative value when the discharge capacity per unit area of the battery in Comparative Example 1 is considered to be “100”.

### Example 2

In an environment with a dew point of −60° C. or lower, the LYBC powder and parachlorotoluene were mixed, and the LYBC powder was finely pulverized using a planetary ball mill to obtain a suspension. An appropriate amount of conductive additive was added to the suspension and mixed with a mixer. The amount of conductive additive was adjusted so that the ratio of the mass of conductive additive to the mass of LYBC would be 5%. In the following Examples and Comparative Examples, the amount of conductive additive was adjusted in the same manner.

The NCM and the suspension were fed into a kneader so that a mass ratio of the NCM to the LYBC would be NCM:LYBC=93.0:7.0, and the solid content ratio was adjusted to 80.0 mass % by adding parachlorotoluene. High-shear kneading was performed under the same conditions as in Example 1 so as to obtain a solid electrolyte composition of Example 2.

A battery of Example 2 was produced by the same method as in Example 1 using the solid electrolyte composition of Example 2. An electrochemical test of the battery in Example 2 was performed in the same manner as in Example 1.

### Example 3

A solid electrolyte composition of Example 3 was produced in the same manner as in Example 2, except that the mass ratio of the NCM and the LYBC was changed to NCM:LYBC=95.2:4.8 and the solid content ratio was changed to 83.0 mass %. A battery of Example 3 was prepared by the same method as in Example 1, using the solid electrolyte composition of Example 3. An electrochemical test of the battery in Example 3 was performed in the same manner as in Example 1.

### Example 4

A solid electrolyte composition of Example 4 was produced in the same manner as in Example 2, except that the mass ratio of the NCM and the LYBC was changed to NCM:LYBC=90.9:9.1 and the solid content ratio was changed to 81.2 mass %. A battery of Example 4 was prepared by the same method as in Example 1 using the solid electrolyte composition of Example 4. An electrochemical test of the battery in Example 4 battery was performed in the same manner as in Example 1.

### Example 5

A LYBC powder and orthochlorotoluene (oCT) were mixed in an environment with a dew point of −60° C. or lower, and the LYBC powder was finely pulverized using a planetary ball mill to obtain a suspension. An appropriate amount of conductive additive was added to the suspension and mixed with a mixer.

NCM and the suspension were fed into a kneader so that a mass ratio of the NCM to the LYBC would be NCM:LYBC=93.0:7.0, to which orthochlorotoluene was added to adjust the solid content ratio to 81.8 mass %. High-shear kneading was performed under the same conditions as in Example 1 to obtain a solid electrolyte composition of Example 5.

A battery of Example 5 was prepared by the same method as in Example 1 using the solid electrolyte composition of Example 5. An electrochemical test of the battery in Example 5 was performed by the same method as in Example 1.

### Example 6

### [Production of Coated Positive Electrode Active Material]

The NCM was used as the positive active material. For the coating material, LiNbO₃ was used. A coating layer including the LiNbO₃ was formed by a liquid phase coating method. Specifically, a precursor solution of LiNbO₃ was first prepared by mixing ethylithium, pentaethoxyniobium, and super dehydrated ethanol. The precursor solution was then applied onto the surface of the NCM. Thereby, a precursor film was formed on the surface of the NCM. Next, the NCM coated with the precursor film was heat treated. The heat treatment advanced gelation of the precursor film, and a coating layer including LiNbO₃ was formed. The NCM with a LiNbO₃ coating layer is hereinafter referred to as “NCM-Nb”.

In an environment with a dew point of −60° C. or lower, a LYBC powder and parachlorotoluene were mixed, and the LYBC powder was finely pulverized using a planetary ball mill to obtain a suspension. An appropriate amount of conductive additive was added to the suspension and mixed with a mixer.

The NCM-Nb and the suspension were fed into a kneader so that a mass ratio of the NCM-Nb to the LYBC would be NCM-Nb:LYBC=93.0:7.0, to which parachlorotoluene was added to adjust the solid content ratio to 82.8 mass %. High-shear kneading was performed under the same conditions as in Example 1 to obtain a solid electrolyte composition of Example 6.

A battery of Example 6 was produced by the same method as in Example 1 using the solid electrolyte composition of Example 6. An electrochemical test of the battery in Example 6 was performed by the same method as in Example 1.

### Example 7

A solid electrolyte composition of Example 7 was produced by the same method as in Example 6, except that the mass ratio of the NCM-Nb to the LYBC was changed to NCM-Nb:LYBC=95.2:4.8 and the solid content ratio was changed to 83.0 mass %. A battery of Example 7 was prepared by the same method as in Example 1 using the solid electrolyte composition of Example 7. An electrochemical test of the battery in Example 7 was performed by the same method as in Example 1.

### Example 8

A solid electrolyte composition of Example 8 was produced in the same manner as in Example 6, except that the mass ratio of the NCM-Nb to the LYBC was changed to NCM-Nb:LYBC=90.9:9.1 and the solid content ratio was changed to 82.4 mass %. A battery of Example 8 was prepared by the same method as in Example 1 using the solid electrolyte composition of Example 8. An electrochemical test of the battery in Example 8 was performed by the same method as in Example 1.

### Example 9

A LYBC powder and parachlorotoluene were mixed in an environment with a dew point of −60° C. or lower, and the LYBC powder was finely pulverized using a planetary ball mill to obtain a suspension. To the suspension, a conductive additive of 1.5 times the mass of Example 1 was added and mixed with a mixer.

The NCM-Nb and the suspension were fed into a kneader so that a mass ratio of the NCM-Nb to the LYBC would be NCM-Nb:LYBC=90.9:9.1, to which parachlorotoluene was added to adjust the solid content ratio to 82.8 mass %. High-shear kneading was performed under the same conditions as in Example 1 to obtain a solid electrolyte composition of Example 9.

A battery of Example 9 was produced by the same method as in Example 1 using the solid electrolyte composition of Example 9. An electrochemical test of the battery of Example 9 was performed by the same method as in Example 1.

### Example 10

A LYBC powder and parachlorotoluene were mixed in an environment with a dew point of −60° C. or lower, and the LYBC powder was finely pulverized using a planetary ball mill to obtain a suspension. An appropriate amount of conductive additive was added to the suspension and mixed with a mixer.

The NCM and the suspension were fed into a planetary mixer (Hi-Vismix 2P-03 manufactured by PRIMIX Corporation) so that a mass ratio of the NCM to the LYBC would be NCM:LYBC=93.0:7.0, to which parachlorotoluene was added to adjust the solid content ratio to 78.9%. High-shear kneading was then performed under the conditions of an argon atmosphere with a dew point of −60° C. at a rotation speed of 100 rpm for one hour. As a result, a solid electrolyte composition of Example 9 was obtained.

A battery of Example 10 was prepared by the same method as in Example 1 using the solid electrolyte composition of Example 10. An electrochemical test of the battery of Example 10 was performed by the same method as in Example 1.

### Example 11

A solid electrolyte composition of Example 11 was produced by the same method as in Example 10, except that the mass ratio of the NCM to the LYBC was changed to NCM:LYBC=90.9:9.1 and the solid content ratio was changed to 83.5 mass %. A battery of Example 11 was produced by the same method as in Example 1 using the solid electrolyte composition of Example 11. An electrochemical test of the battery in Example 11 was performed by the same method as in Example 1.

### Comparative Example 1

A LYBC powder and parachlorotoluene were mixed in an environment with a dew point of −60° C. or lower, and the LYBC powder was pulverized using a planetary ball mill to obtain a suspension. An appropriate amount of conductive additive was added to the suspension and mixed with a mixer.

NCM and a suspension were mixed so that a volume ratio of the NCM to the LYBC would be NCM:LYBC=70:30, and the mixture was dispersed in a homogenizer. A binder and a solvent were added to the mixture, and each material was dispersed in a homogenizer to produce a slurry of Comparative Example 1.

The slurry was applied onto a current collector to form a coating film. The coating film was dried on a hot plate to prepare a positive electrode. Using this positive electrode, a battery of Comparative Example 1 was produced by the same method as in Example 1. An electrochemical test of the battery in Comparative Example 1 was performed by the same method as in Example 1.

### Example 12

### [Production of Solid Electrolyte Composition]

A coating layer of LiNbO₃ was formed on the surface of Li(NiCoAl)O₂ (hereinafter referred to as NCA) by the same method as in Example 6, except that the NCA was used as a positive active material. The NCA with a LiNbO₃ coating layer is hereinafter referred to as “NCA-Nb”.

A LPS powder and tetralin (THN) were mixed in an environment with a dew point of −60° C. or lower, and the LPS was dispersed in the tetralin using a homogenizer to obtain a suspension.

The NCA-Nb and the suspension were fed into a planetary mixer so that a mass ratio of the NCA-Nb to the LPS would be NCA-Nb:LPS=91.3:8.7, to which tetralin was added to adjust the solid content ratio to 77.5 mass %, and high-shear kneading was performed under the conditions of an argon atmosphere with a dew point of −60° C. at a rotation speed of 100 rpm for one hour. Thereby, a solid electrolyte composition of Example 12 was obtained.

### [Production of Positive Electrode]

The solid electrolyte composition and a LPS were mixed in an argon glove box with a dew point of −60° C. or lower to obtain a mixture. The ratio of the NCA-Nb to the LPS in the mixture was NCA-Nb:LYBC=70:30 by volume. The mixture was treated in a homogenizer to disperse the NCA-Nb and the LYBC. A binder, a solvent, and a conductive additive were added to the mixture, and these were dispersed in a homogenizer to obtain a slurry.

The slurry was applied onto the current collector to form a coating film. The coating film was dried on a hot plate to produce a positive electrode of Example 12.

The thickness of the coating film was adjusted in each of Example 12 and Comparative Example 2 so that the mass of the positive active material layer after drying would be the same.

### [Production of Battery]

Using the positive electrode of Example 12, a battery of Example 12 was produced by the same method as in Example 1.

### [Electrochemical Test]

An electrochemical test of the battery of Example 12 was performed by the same method as in Example 1. The results are shown in Table 1. In Table 2, the item “discharge capacity” is expressed as a relative value when the discharge capacity per unit area of the battery in Comparative Example 2 is considered to be “100.

### Comparative Example 2

ALPS, tetralin and binder were mixed in an environment with a dew point of −60° C. or lower, and each material was dispersed in a homogenizer to obtain a dispersion solution. The NCA-Nb and the LPS were mixed so that a volume ratio of the NCA-Nb to the LPS would be NCA-Nb:LPS=70:30, and each material was dispersed in a homogenizer. A conductive additive was added thereto, and a slurry was prepared by dispersing the conductive additive in a homogenizer.

The slurry was applied onto the current collector to form a coating film. The coating film was dried on a hot plate to produce a positive electrode of Comparative Example 2.

Using the positive electrode of Comparative Example 2, a battery of Comparative Example 2 was prepared by the same method as in Example 1. An electrochemical test of the battery in Comparative Example 2 was performed by the same method as in Example 1.

TABLE 1

| | Material to be high-shear kneaded | | |
|---|---|---|---|
| | Active material | Solid electrolyte | Solvent |
| Example 1 | NCM | LYBC | pCT |
| Example 2 | NCM | LYBC | pCT |
| Example 3 | NCM | LYBC | pCT |
| Example 4 | NCM | LYBC | pCT |
| Example 5 | NCM | LYBC | oCT |
| Example 6 | NCM-Nb | LYBC | pCT |
| Example 7 | NCM-Nb | LYBC | pCT |
| Example 8 | NCM-Nb | LYBC | pCT |
| Example 9 | NCM-Nb | LYBC | pCT |
| Example 10 | NCM | LYBC | pCT |
| Example 11 | NCM | LYBC | pCT |
| Comparative | NCM | LYBC | — |
| Example 1 | | | |

| | Requirement for high-shear kneading | | | | | |
|---|---|---|---|---|---|---|
| | | | | Solid | | |
| | Active | Solid | | content | | |
| | material | electrolyte | Conductive | ratio | | Discharge |
| | (mass %) | (mass %) | additive | (mass %) | Device | capacity |
| Example 1 | 93.0 | 7.0 | Not | 80.9 | Kneader | 130 |
| | | | included | | | |
| Example 2 | 93.0 | 7.0 | Included | 80.0 | Kneader | 126 |
| Example 3 | 95.2 | 4.8 | Included | 83.0 | Kneader | 124 |
| Example 4 | 90.9 | 9.1 | Included | 81.2 | Kneader | 134 |
| Example 5 | 93.0 | 7.0 | Included | 81.8 | Kneader | 126 |
| Example 6 | 93.0 | 7.0 | Included | 82.8 | Kneader | 139 |
| Example 7 | 95.2 | 4.8 | Included | 83.0 | Kneader | 136 |
| Example 8 | 90.9 | 9.1 | Included | 82.4 | Kneader | 135 |
| Example 9 | 90.9 | 9.1 | Included | 82.8 | Kneader | 139 |
| | | | (weight | | | |
| | | | increase) | | | |
| Example 10 | 93.0 | 7.0 | Included | 78.9 | Planetary | 126 |
| | | | | | mixer | |
| Example 11 | 90.9 | 9.1 | Included | 83.5 | Planetary | 114 |
| | | | | | mixer | |
| Comparative | — | — | — | — | — | 100 |
| Example 1 | | | | | | |

TABLE 2

| | Material to be high-shear kneaded | | |
|---|---|---|---|
| | Active material | Solid electrolyte | Solvent |
| Example 12 | NCA-Nb | LPS | THN |
| Comparative | NCA-Nb | LPS | — |
| Example 2 | | | |

| | Requirement for high-shear kneading | | | | | |
|---|---|---|---|---|---|---|
| | | | | Solid | | |
| | Active | Solid | | content | | |
| | material | electrolyte | Conductive | ratio | | Discharge |
| | (mass %) | (mass %) | additive | (mass %) | Device | capacity |
| Example 12 | 91.3 | 8.7 | Not | 77.5 | Planetary | 101 |
| | | | included | | mixer | |
| Comparative | — | — | — | — | — | 100 |
| Example 2 | | | | | | |

### <<Consideration>>

As shown in Tables 1 and 2, batteries in Examples exhibited higher discharge capacities than the batteries in Comparative Examples. The resistance of the battery was lowered, the average discharge voltage and discharge capacity increased, and the energy per unit area rose. The reason for this is thought to be formation of a composite with a favorable interface between the active material and the solid electrolyte.

The ease in forming the interface between the active material and the solid electrolyte when the high-shear kneading step is not employed differs depending on the type of materials. Therefore, there was found a difference between Examples 1-11 and Example 12 in the degree of improvement compared to the Comparative Example.

In the high-shear kneading step, the solid content ratio to determine the state and viscosity is important. Due to the structure of the kneader, the ratio of the volume of blade to the capacity of the chamber is relatively large. Therefore, a kneader can apply a strong shear force to the material. As a result, the range of solid content ratio applicable to the kneader is relatively wide, and highly efficient high-shear kneading can be achieved. However, the amount that can be treated at one time by the kneader is small.

In contrast, a planetary mixer has a relatively large capacity of container for holding materials compared to the capacity of a blade, making it possible to knead large amounts of materials at once. However, since it is difficult to apply a shear force to the material in the container, the range of solid content ratio applicable to a planetary mixer is relatively narrow.

### INDUSTRIAL APPLICABILITY

The technique of the present disclosure is useful, for example, for an all-solid-state battery.

What is claimed is:

1. A solid electrolyte composition comprising:
a solvent;
an active material; and
a solid electrolyte, wherein
the solid electrolyte composition is powdery or clayey, and
the active material and the solid electrolyte form a composite.

2. The solid electrolyte composition according to claim 1, being clayey.

3. The solid electrolyte composition according to claim 1, wherein a solid content ratio is 72 mass % or more and 88 mass % or less.

4. The solid electrolyte composition according to claim 1, being free of a binder.

5. A method for manufacturing a solid electrolyte composition, comprising high-shear kneading a mixture including a solvent, an active material, and a solid electrolyte.

6. The manufacturing method according to claim 5, wherein
the mixture is clayey.

7. The manufacturing method according to claim 5, wherein
a solid content ratio of the mixture is 72 mass % or more and 88 mass % or less.

8. The manufacturing method according to claim 5, wherein the solid content ratio of the mixture is 77 mass % or more and 84 mass % or less.

9. The manufacturing method according to claim 5, wherein
the mixture is free of a binder.

10. The manufacturing method according to claim 5, wherein
the solid electrolyte includes at least one selected from the group consisting of a sulfide solid electrolyte and a halide solid electrolyte.

11. A method for manufacturing an electrode slurry, comprising adding a solvent to the solid electrolyte composition according to claim 1.

12. A method for manufacturing an electrode, comprising:
molding the solid electrolyte composition according to claim 1.

13. A method for manufacturing a battery, comprising:
molding the solid electrolyte composition according to claim 1.
